(19) United States
(12) Patent Application Publication
(10) Pub. No.: US 2025/0353790 A1
(43) Pub. Date: Nov. 20, 2025

(54) ALKALI ACTIVATION OF COAL ASHES HAVING LOW REACTIVITY FOR SUSTAINABLE CONSTRUCTION

(71) Applicant: University of Alaska Fairbanks, Fairbanks, AK (US)

(72) Inventor: Nima Farzadnia, Fairbanks, AK (US)

(21) Appl. No.: 19/208,344

(22) Filed: May 14, 2025

Related U.S. Application Data
(60) Provisional application No. 63/647,296, filed on May 14, 2024.

(51) Int. Cl. C04B 28/02; B33Y 10/00; B33Y 70/00; C04B 28/06

(52) U.S. Cl. CPC C04B 28/021; B33Y 10/00; B33Y 70/00; C04B 28/06; C04B 2201/50

(57) ABSTRACT

Disclosed are methods of making a cementitious composite material using a low reactivity coal ash. Also disclosed herein are cementitious composite materials.

### CROSS-REFERENCE TO RELATED APPLICATIONS

This application claims the benefit of U.S. Provisional Application No. 63/647,296, filed on May 14, 2024, which is incorporated herein by reference in its entirety.

### BACKGROUND

Concrete is a composite material typically containing aggregate, such as mineral particulates, bound together with a fluid cement that cures to a solid over time. It is the most widely used building material, and the most manufactured material in the world.

Coal ash is a by-product of combustion in coal-burning power plants and can have a negative impact on the environment if not effectively recycled. Coal ashes with high reactivity have already found wide application in concrete production, either as supplementary cementitious materials or as the primary component in binders known as Alkali Activated Materials (AAM).

However, low reactivity coal ash remains unusable in current techniques used for AAM-based concretes. It would be advantageous to incorporate low reactivity coal ash into AAM-based concretes, as such incorporation would reduce transportation costs by eliminating the need for Portland Cement (PC) and other imported binders, particularly in remote regions where coal ash is locally abundant, as well as advantageously lower the environmental impacts of this industrial waste.

Therefore, there remains a need in the art for cementitious composite materials which can be produced with low reactivity coal ash. There also remains a need in the art for methods which produce cementitious composite materials which can be cured without additional thermal curing, compared to conventional processes, which typically require application of heat to cure. Such needs are addressed herein.

### SUMMARY

In accordance with the purpose(s) of the invention as embodied and broadly described herein, the invention, in one aspect, relates to methods of making a composite material, such as a cementitious composite material, using low reactivity coal ashes.

Disclosed herein is a method of making a cementitious composite material, comprising: a) forming a reaction mixture comprising: i) a cementitious reactive precursor powder comprising a low reactivity coal ash, wherein the low reactivity coal ash comprises less than 70% by weight of a combined sum of CaO, SiO₂, and Al₂O₃; ii) an alkali activator; and iii) water; and b) reacting the reaction mixture of a) to provide the cementitious composite material.

Also disclosed herein is a cementitious composite material formed by the methods disclosed herein.

Also disclosed herein is a cementitious composite material comprising: a low reactivity coal ash, wherein the low reactivity coal ash comprises less than 70% by weight of a combined sum of CaO, SiO₂, and Al₂O₃; and an alkali activator.

Additional aspects of the invention will be set forth, in part, in the detailed description, and claims that follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF DRAWINGS

FIG. 1A is a representative scanning electron microscope (SEM) image of low reactivity fly ash.

FIG. 1B is a representative SEM image of low reactivity bottom ash.

FIG. 2A is a representative SEM image of fly ash after alkali activation within the cementitious composite material matrix.

FIG. 2B is a representative SEM of dense microstructure of the cementitious composite material.

FIG. 3 is a bar graph showing representative values for the compressive strength measured for selected samples on different testing days.

### DETAILED DESCRIPTION

The present invention can be understood more readily by reference to the following detailed description, examples, drawings, and claims, and their previous and following description. However, before the present materials, systems, and/or methods are disclosed and described in further detail, it is to be understood that this invention is not limited to the specific or exemplary aspects of materials, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

As used herein, the singular forms “a,” “an” and “the” include plural referents unless the context clearly dictates otherwise. Thus, for example, reference to a “coal ash” includes aspects having two or more such coal ash materials unless the context clearly indicates otherwise.

As used herein, the term “comprising” can include the aspects “consisting of” and “consisting essentially of.” The term “comprising” can also mean “including but not limited to.”

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular stated value forms another aspect. It should be further understood that the endpoints of each of the ranges are significant both in relation to the other endpoint, and independently of the other endpoint. Moreover, in still further aspects, reference to a parameter that equals a particular endpoint or specific value also includes aspects that are characterized as being greater than the stated value or, alternatively, less than the stated value.

As used herein, the terms “optional” or “optionally” mean that the subsequently described event or circumstance may or may not occur, and that the description includes instances where said event or circumstance occurs and instances where it does not.

As used herein, the term “low reactivity coal ash,” refers to coal ashes, such as fly ashes or bottom ashes, which contain lower concentrations of CaO, SiO₂, and Al₂O₃ relative to more reactive coal ashes. In some aspects, the low reactivity coal ash can be characterized by its containing a combined weight percent of CaO, SiO₂, and Al₂O₃ that is less than 70 wt %. Further, the low reactivity coal ashes typically contain particles with coarser grain sizes relative to more reactive coal ashes. In some aspects, the low reactivity coal ash can be characterized as a particulate material comprising particles having a median size greater than about 50 μm. In further aspects, the low reactivity coal ash comprises particles having a median size in the range of from about 50 μm to about 400 μm.

As used herein, the term “calcium bearing material” refers to any supplemental source of calcium, which is supplemental to and not present within the composition of the low reactivity coal ash. Examples of suitable calcium bearing materials can include, but are not limited to, CaOH and CaO.

Where a component or combination of components is described as having one or more parts present in varying weight percentage amounts based on the total weight of a stated component or combination of components, it should be understood the total weight percentage of the combined or recited parts does not exceed 100 weight %.

The present invention may be understood more readily by reference to the following detailed description of various aspects of the invention and the examples included therein and to the Figures and their previous and following description.

### Methods of Making a Cementitious Composite Material

In various aspects, the disclosure herein relates to methods of making a cementitious composite material, comprising: a) forming a reaction mixture comprising: i) a cementitious reactive precursor powder comprising a low reactivity coal ash, wherein the low reactivity coal ash comprises less than 70% by weight of a combined sum of CaO, SiO₂, and Al₂O₃; ii) an alkali activator; and iii) water; and b) reacting the mixture of a) to provide the cementitious composite material.

The method described herein utilizes a novel formulation containing low reactivity coal ash as an alternative binder for cementitious composite materials. Coal ash, containing fly ash and bottom ash, is a by-product of combustion in coal-burning power plants and can have a negative impact on the environment if not effectively recycled. The method described herein allows for the full utilization of coal ash with low reactivity as the primary material for constructing both surface and vertical infrastructure. Coal ash having low reactivity is primarily attributed to the coarser grain size of ashes, lower content of reactive oxides (namely CaO, SiO₂, Fe₂O₃, and Al₂O₃), and higher content of impurities. Typically, such ashes cannot be used in the construction industry due to their low reactivity. However, using such ashes in construction can advantageously reduce transportation costs by eliminating the need for Portland Cement (PC) and other imported binders, particularly in remote regions where coal ash is locally abundant, as well as advantageously lower the environmental impacts of this industrial waste.

Coal ashes with high reactivity have already found wide application in concrete production, either as supplementary cementitious materials or as the primary component in binders known as Alkali Activated Materials (AAM). Alkali activation offers a promising pathway for utilizing coal ashes as sustainable alternatives to Portland Cement (PC). The AAMs are highly promising alternatives to PC, with several studies reporting superior mechanical and environmental benefits. AAM-based concretes can achieve a comparable compressive strength to PC concrete. Furthermore, AAMs have shown excellent resistance to fire, water, chloride penetration, abrasion, and chemical attacks leading to reduced maintenance and repair costs in the long term. Additionally, AAMs facilitate the use of waste materials (e.g., industrial by-products and agricultural wastes), eliminating the use of PC and leading to lower carbon emissions and construction costs.

Alkali-activation is a proven process of accelerating the dissolution rate and reactivity of aluminosilicates (e.g., fly ash, bottom ash, and slag), also known as precursors, by adding water-based alkali activators (e.g., NaOH, Na₂CO₃, Na₂O(SiO₂)ₙ, etc.). Without wishing to be bound by theory, this facilitates the dissolution of glassy and reactive phases of aluminosilicates through OH ions attacking Si—O—Si and Al—O—Si bonds. As a result, calcium and aluminosilicate ions are released into the system. As the concentrations of these species increase, calcium-silicate and/or aluminosilicate species start to polymerize to form colloidal particles, which grow and eventually precipitate to form the binder phase of concrete. However, low reactivity of coal ashes can inhibit this process. The methods described herein develop alkali activation processes which incorporate low reactivity coal ashes to form cementitious composite materials. These materials are suitable for use in a variety of applications, including for example in soil stabilization and infrastructure construction applications. Furthermore, the methods described herein do not require thermal curing and thus the reaction and curing can occur under ambient conditions of pressure and temperature. If desired, a compaction step can also be used during eh reaction and curing for applications which require higher compressive strength. Lastly, the methods described herein do not require highly corrosive materials, such as NaOH, and more locally available and user-friendly alkali activators may be used.

### A. Forming a Reaction Mixture

The method described herein comprises a) forming a reaction mixture comprising: i) a cementitious reactive precursor powder comprising a low reactivity coal ash, wherein the low reactivity coal ash comprises less than 70% by weight of a combined sum of CaO, SiO₂, and Al₂O₃; ii) an alkali activator; and iii) water. The reaction mixture is then reacted for a period of time to at least partially cure and form the composite material.

In various aspects, the low reactivity coal ash is fly ash, bottom ash, or a combination thereof. In further aspects, the low reactivity coal ash is fly ash. In yet further aspects, the low reactivity coal ash is bottom ash.

Low reactivity coal ash can be characterized by having lower amounts of CaO, SiO₂, and Al₂O₃ relative to higher reactivity coal ash. Thus, the low reactivity coal ash in the reaction mixture comprises less than 70% by weight of a combined sum of CaO, SiO₂, and Al₂O₃. The low reactivity coal ash in the reaction mixture can comprise, for example, less than 65%, less than 60%, or less than 55% by weight of a combined sum of CaO, SiO₂, and Al₂O₃. The low reactivity coal ash in the reaction mixture can comprise, for example, 1% to 70%, 1% to 65%, 1% to 60%, 1% to 55%, 10% to 70%, 10% to 65%, 10% to 60%, 10% to 55%, 20% to 70%, 20% to 65%, 20% to 60%, 20% to 55%, 30% to 70%, 30% to 65%, 30% to 60%, 30% to 55%, 40% to 70%, 40% to 65%, 40% to 60%, 40% to 55%, 50% to 70%, 50% to 65%, or from 50% to 60% by weight of a combined sum of CaO, SiO₂, and Al₂O₃.

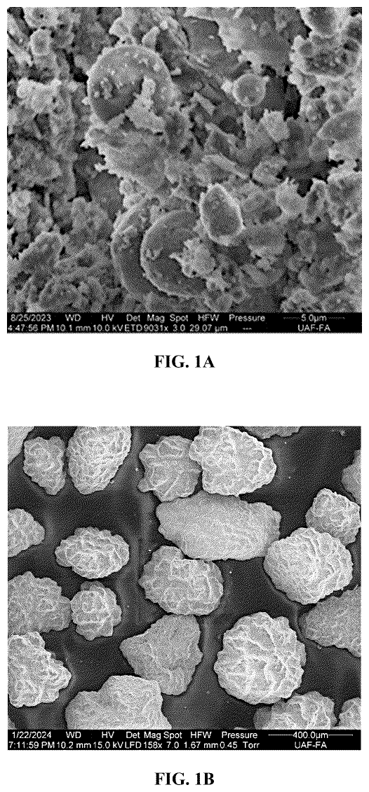

FIG. 1A-1B show scanning electron microscopic (SEM) images of samples of exemplary low reactivity fly ash (FIG. 1A) and bottom ash (FIG. 1B) obtained from the University of Alaska Fairbanks (UAF) power plant. The images show the impurity and coarse size of grains in both fly ash and bottom ash. Table 1 also shows the chemical compositions of these low reactivity coal ashes which indicate their lower contents of CaO, SiO₂, and Al₂O₃ compared to high reactivity coal ashes. High reactivity coal ashes contain more than 70 wt % of SiO₂+Al₂O₃+CaO and typically contain more than 40 wt % CaO. In this example, low reactivity is also due to the coarseness of the ashes.

TABLE 1

| Oxide | Fly Ash (wt %) | Bottom Ash (wt %) |
|---|---|---|
| Na₂O | 0.78% | 0.21% |
| MgO | 3.98% | 4.57% |
| Al₂O₃ | 17.26% | 10.10% |
| SiO₂ | 31.09% | 13.91% |
| SO₃ | 6.25% | 3.93% |
| K₂O | 0.81% | 0.53% |
| CaO | 32.05% | 53.87% |
| TiO₂ | 0.78% | 0.35% |
| MnO | 0.13% | 0.23% |
| Fe₂O₃ | 6.06% | 11.67% |

The low reactivity coal ash can also be characterized by coarser grain or particle sizes relative to higher reactivity coal ashes. The median diameter of higher reactivity fly ash, for example, is typically below 50 μm. Thus, in some aspects, the low reactivity coal ash comprises particles having a median diameter of 50 μm or more. The low reactivity coal ash can comprise particles having a median diameter of 50 μm or more, 60 μm or more, 70 μm or more, 80 μm or more, 90 μm or more, 100 μm or more, 200 μm or more, or 300 μm or more. In some aspects, the low reactivity coal ash comprises particles having a mean diameter of less than 400 μm. In various aspects, the low reactivity coal ash comprises particles having a median diameter of 50 μm to 400 μm. The low reactivity coal ash can comprise particles having a median diameter of 50 μm to 350 μm, 50 μm to 300 μm, 50 μm to 200 μm, 50 μm to 100 μm, 75 μm to 400 μm, 75 μm to 350 μm, 75 μm to 300 μm, 75 μm to 200 μm, 100 μm to 400 μm, 100 μm to 350 μm, 100 μm to 300 μm, 200 μm to 400 μm, 200 μm to 350 μm, 200 μm to 300 μm, or 300 μm to 400 μm.

Table 2 also shows the particles size gradation of an exemplary low reactivity fly ash with median size of 150 microns. The median size of higher reactivity fly ash is typically below 50 micron.

TABLE 2

| Sieve Number | Retained on Sieve (%) |
|---|---|
| No. 40 | 2.0% |
| No. 70 | 35.6% |
| No. 100 | 10.0% |
| No. 200 | 22.4% |
| Pan | 30.0% |

In aspects where Na₂O is present as an activator, the silica modulus is the ratio of silica (SiO₂) to Na₂O in the activator. In some aspects, the low reactivity coal ash has a silica modulus of 0.5 to 1.5. The low reactivity coal ash can have a silica modulus of, for example, 0.5 to 1.4, 0.5 to 1.2, 0.5 to 1.0, 0.5 to 0.8, 0.5 to 0.6, 0.6 to 1.5, 0.6 to 1.4, 0.6 to 1.2, 0.6 to 1.0, 0.6 to 0.8, 0.8 to 1.5, 0.8 to 1.4, 0.8 to 1.2, 0.8 to 1.0, 1.0 to 1.5, 1.0 to 1.4, 1.0 to 1.2, 1.2 to 1.5, 1.2 to 1.4, or 1.4 to 1.5. The low reactivity coal ash can have a silica modulus of, for example, about 0.5, 0.6, 0.7, 0.8, 0.9, 1.0, 1.1, 1.2, 1.3, 1.4, or about 1.5.

In various aspects, the coal ash can be present in the reaction mixture in an amount in the range of from about 65 wt % to about 85 wt %. In other aspects, the low reactivity coal ash can be present in an amount of, for example, 65 wt % to 80 wt %, 65 wt % to 75 wt %, 65 wt % to 70 wt %, 70 wt % to 85 wt %, 70 wt % to 80 wt %, 70 wt % to 75 wt %, 75 wt % to 85 wt %, 75 wt % to 80 wt %, or 80 wt % to 85 wt %. The low reactivity coal ash can also be present in an amount of, for example, about 65 wt %, 70 wt %, 75 wt %, 80 wt %, or about 85 wt %. Still further, in other aspects, the low reactivity coal ash can be present, for example, in an amount of at least 65 wt %, 70 wt %, 75 wt %, or at least 80 wt %. The low reactivity coal ash can be present, for example, in an amount of at less than 70 wt %, 80 wt %, or less than 85 wt %. Any of the foregoing coal ash weight percentage ranges or values can in one aspect be relative to the total combined weight of the precursor powder composition and alkali activator. Alternatively, in other aspects, any of the foregoing coal ash weight percentage ranges or values can be relative to the weight of the entire reaction mixture, including water.

The reaction mixture further comprises an alkali activator component. The alkali activator can be any compound which is a basic, ionic salt of an alkali or an alkaline earth metal. In various aspects, the alkali activator can be NaOH, KOH, Na₂CO₃, Na₂O(SiO₂)ₙ, or CaCO₃. The alkali activator is present in the reaction mixture in an amount up to about 20 weight percent %. For example, the alkali activator can be present in an amount of, for example, up to 5 wt %, up to 10 wt %, up to 15 wt %, up to 18 wt %, or up to 20 wt %. In some aspects, the alkali activator can present in an amount of, for example, less than 18 wt %, 15 wt %, 10 wt %, 5 wt %, 4 wt %, 3 wt %, 2 wt %, or less than 1 wt %. In still further aspects, the alkali activator can be present in an amount in the range of from 0.1 wt % to 20 wt %, 0.1 wt % to 18 wt %, 0.1 wt % to 15 wt %, 0.1 wt % to 10 wt %, 0.1 wt % to 5 wt %, 0.1 wt % to 1 wt %, 0.1 wt % to 0.5 wt %, 0.5 wt % to 20 wt %, 0.5 wt % to 18 wt %, 0.5 wt % to 15 wt %, 0.5 wt % to 10 wt %, 0.5 wt % to 5 wt %, 0.5 wt % to 1 wt %, 1 wt % to 20 wt %, 1 wt % to 15 wt %, 1 wt % to 10 wt %, 1 wt % to 5 wt %, 5 wt % to 20 wt %, 5 wt % to 15 wt %, 5 wt % to 10 wt %, 10 wt % to 20 wt %, 10 wt % to 15 wt %, or 15 wt % to 20 wt %. Any of the foregoing alkali activator weight percentage ranges or values can in one aspect be relative to the total combined weight of the precursor powder composition and alkali activator. Alternatively, in other aspects, any of the foregoing alkali activator weight percentage ranges or values can be relative to the weight of the entire reaction mixture, including water.

The cementitious reactive precursor powder can optionally further comprises a calcium bearing material, which in some aspects can be incorporated into the reaction mixture for further enhancing the strength properties of the resulting composite. In such aspects, the amount of calcium bearing material is introduced as a supplemental additive and is separate from any calcium content that may already be contained and present in the low reactivity coal ash.

The calcium bearing material is a calcium containing compound. For example, the calcium bearing material can comprise CaO or CaOH. When present in the reaction mixture, the calcium bearing material can be present in an amount up to about 15 weight percent %. In further aspects, the calcium bearing material can be present in an amount of, for example, up to 1 wt %, 5 wt %, 7 wt %, 10 wt %, 13 wt %, or up to 15 wt %. Still further, the reaction mixture can comprise, for example, less than 15 wt %, less than 13 wt %, less than 10 wt %, or less than 5 wt % of the calcium bearing material. In still further aspects, the calcium bearing material can be present in an amount in exemplary ranges of from 1 wt % to 15 wt %, 1 wt % to 13 wt %, 1 wt % to 10 wt %, 1 wt % to 5 wt %, 5 wt % to 15 wt %, 5 wt % to 13 wt %, 5 wt % to 10 wt %, 10 wt % to 13 wt %, 10 wt % to 15 wt %, or 13 wt % to 15 wt %. Any of the foregoing calcium bearing material weight percentage ranges or values can in one aspect be relative to the total combined weight of the precursor powder composition and alkali activator. Alternatively, in other aspects, any of the foregoing calcium bearing material weight percentage ranges or values can be relative to the weight of the entire reaction mixture, including water.

In an exemplary aspect, the reaction mixture comprises: a) from 65 to 80 weight percent of the low reactivity coal ash; b) from 0 to 15 weight percent of the calcium bearing material; and c) about 20 weight percent of the alkali activator; wherein the weight percentages are based on the combined total weight of the precursor powder and alkali activator present in the reaction mixture, and wherein the combined weight percentages do not exceed 100%.

In some aspects, both the reactive precursor powder and the alkali activator comprise particles having a mean diameter of less than 400 μm. For example, in various aspects, both the reactive precursor powder and the alkali activator comprise particles having a median diameter of 50 μm to 400 μm. Still further, in other aspects, both the reactive precursor powder and the alkali activator can comprise particles having a median diameter of 50 μm to 350 μm, 50 μm to 300 μm, 50 μm to 200 μm, 50 μm to 100 μm, 75 μm to 400 μm, 75 μm to 350 μm, 75 μm to 300 μm, 75 μm to 200 μm, 100 μm to 400 μm, 100 μm to 350 μm, 100 μm to 300 μm, 200 μm to 400 μm, 200 μm to 350 μm, 200 μm to 300 μm, or 300 μm to 400 μm

In various aspects, the reaction mixture can comprise an initial ratio of liquid-to-solids of 0.4 to 0.6, such as 0.5.

In some aspects, the dry components of the reaction mixture, including the reactive precursor powder and the alkali activator can be pre-blended prior to addition of water. In such aspects, these components are a dry mix, i.e., there are no fluid components in the precursor powder and alkali activator. In this aspect, providing the reaction mixture further comprises the step of then adding water to the dry mix of the precursor powder and alkali activator. Further, in such aspects, it will be appreciated that the precursor powder and the alkali activator can be conveniently prepackaged in powdered form, similar to dry formulations of Portland cement, and then conveniently utilized by the user by adding water prior to mixing. This can enhance construction ease and efficiency.

In other aspects, the alkali activator can first be mixed with the water component to develop the alkali activator and form a pre-blended solution having a molarity in the range of from, for example, about 10 M to 14 M. This resulting alkali activator solution can then be mixed together with the reactive precursor powder to provide the reaction mixture. In other aspects, the aqueous alkali activator solution can be prepared to have a molarity in the range of from 10 M to 13 M, 10 M to 12 M, 10 M to 11 M, 11 M to 14 M, 11 M to 13 M, 11 M to 12 M, 12 M to 14 M, 12 M to 13 M, or 13 M to 14 M. Still further, the alkali activator solution can have a molarity of, for example, about 10 M, about 11 M, about 12 M, about 13 M, or about 14 M.

In aspects where the alkali activator is first mixed with water to form the aqueous alkali activator solution of a desired molarity, it should be understood that the amount of that solution to be blended with the reactive precursor composition can be determined by determining the volume of solution necessary to incorporate the desired amount of alkali activator into the reaction mixture. Similarly, in aspects where the alkali activator is first dry blended or premixed with the reactive precursor powder, the amount of water to be blended to provide the reaction mixture can again be determined from the amount of alkali activator present in the dry mixture. The volume of water needed can be that amount necessary to form an alkali activator solution in situ of essentially the same desired molarity as the alkali activator solution described above and to form a reaction mixture similar or the same to that as if the alkali activator had been first mixed with water.

The reaction mixture can be mixed or blended for a desired period of time to homogenize the mixture and enhance reaction. For example, the reaction mixture can be blended or mixed for a period of about 1 min to 5 min. The reaction mixture can be mixed, for example, for 1 min to 4 min, 1 min to 3 min, 1 min to 2 min, 2 min to 5 min, 2 min to 4 min, 2 min to 3 min, 3 min to 5 min, 3 min to 4 min, or 4 min to 5 min. The reaction mixture can be mixed, for example, for about 1 min, about 2 min, about 3 min, about 4 min, or about 5 min.

In various aspects, mixing the reaction mixture and the reacting of the reaction mixture can occur at ambient temperature conditions. Ambient temperature conditions can include those conditions typically understood as ambient indoor conditions. Alternatively, ambient temperature conditions can also include conditions typically found outdoors in a particular geographic location. For example, ambient temperature conditions can include a temperature in the range of from greater than 0° C. to 35° C., including for example, temperatures of 5° C., 10° C., 15° C., 20° C., 25° C. or 30° C. Still further, ambient temperature conditions can include temperatures in the range of from 20° C. to 30° C., 20° C. to 25° C., 25° C. to 35° C., 25° C. to 30° C., or 30° C. to 35° C.

### B. Reacting the Mixture

After forming the reaction mixture in step a), the method comprises step b), reacting the mixture of a) to provide the cementitious composite material.

In some aspects, the reaction mixture is formed into any desired end use configuration prior to completion of the reaction and curing. Forming the desired configuration can include, for example, pouring the reaction mixture into a mold to form a cast, curing the reaction mixture to form the cementitious composite material, and removing the cast. Alternatively, the reaction mixture can be deposited in a layer-by-layer technique using, for example, additive manufacturing infrastructure. It is contemplated the disclosed cementitious composite can be used in any desired infrastructure construction application or soil stabilization.

Thus, in some aspects, forming into the desired configuration comprises pouring the reaction mixture into a mold, curing the reaction mixture to form a cast, and removing the cast to form the cementitious composite material. To enhance the engineering properties, additional curing regimes such as compaction can be applied when higher strength is desired. In further aspects, step b) further comprises applying compression during the curing.

In some aspects, forming into the desired configuration comprises an additive deposition process, such as a three dimensional printing of the reaction mixture to form the cementitious composite material in a desired configuration.

In contrast to conventional processes, in some aspects, the reaction mixture can be fully cured at ambient temperatures, and does not require thermal curing. Thus, in some aspects, a thermal curing is not required.

In some aspects, step b) is performed at ambient temperature, such as at 25° C. In a further aspect, step b) is performed at a temperature of 20° C. to 35° C. Step b) can be performed, for example, at a temperature of 20° C. to 30° C., 20° C. to 25° C., 25° C. to 35° C., 25° C. to 30° C., or 30° C. to 35° C. In further aspects, step b) is performed at 25° C.

In still further aspects, the reaction mixture can be blended with a conventional aggregate material to provide a concrete precursor composition that can then be reacted and cured to form a concrete composite composition.

### Properties of Cementitious Composite Materials

Also disclosed herein is a cementitious composite material formed by the methods described herein. The cementitious composite material offers engineering properties and durability comparable to its conventional Portland cement counterpart, thus making it a suitable alternative for application in which Portland cement is often used.

In various aspects, disclosed herein is a cementitious composite material comprising: a low reactivity coal ash, wherein the low reactivity coal ash comprises less than 70% by weight of a combined sum of CaO, SiO₂, and Al₂O₃; and an alkali activator.

In various aspects, the cementitious composite material exhibits a compressive strength of 1000 psi to 6000 psi after a period of 28 days at an ambient temperature. The cementitious composite material can exhibit, for example, a compressive strength of 1000 psi to 5500 psi, 1000 psi to 5000 psi, 1000 psi to 4500 psi, 1000 psi to 4000 psi, 1000 psi to 3500 psi, 1000 psi to 3000 psi, 1000 psi to 2000 psi, 2000 psi to 6000 psi, 2000 psi to 5500 psi, 2000 psi to 5000 psi, 2000 psi to 4500 psi, 2000 psi to 4000 psi, 2000 psi to 3000 psi, 3000 psi to 6000 psi, 3000 psi to 5500 psi, 3000 psi to 5000 psi, 3000 psi to 4500 psi, 3000 psi to 4000 psi, 4000 psi to 6000 psi, 4000 psi to 5500 psi, 4000 psi to 5000 psi, 4000 psi to 4500 psi, or 4000 psi to 5000 psi after a period of 28 days at ambient temperature. In further aspects, the cementitious composite material exhibits a compressive strength of 4000 psi to 6000 psi after a period of 28 days at a temperature.

Also disclosed herein is a concrete composite comprising the cementitious composite material as disclosed herein.

### Aspects

In view of the disclosure herein below are described certain more particularly described aspects of the inventions. These particularly recited aspects should not however be interpreted to have any limiting effect on any different claims comprising different or more general teachings described herein, or that the “particular” aspects are somehow limited in some way other than the inherent meanings of the language and formulas literally used therein.

Aspect 1: A method of making a cementitious composite material, comprising: a) forming a reaction mixture comprising: i) a cementitious reactive precursor powder comprising a low reactivity coal ash, wherein the low reactivity coal ash comprises less than 70% by weight of a combined sum of CaO, SiO₂, and Al₂O₃; ii) an alkali activator; and iii) water; and b) reacting the mixture of a) to provide the cementitious composite material.

Aspect 2: The method of aspect 1, wherein the low reactivity coal ash is fly ash or bottom ash.

Aspect 3: The method of aspect 1 or 2, wherein the alkali activator is NaOH, KOH, or CaCO₃.

Aspect 4: The method of any of aspects 1-3, wherein the cementitious reactive precursor powder further comprises a calcium bearing material.

Aspect 5: The method of aspect 4, wherein the calcium bearing material is CaO or CaOH.

Aspect 6: The method of aspect 4 or 5, wherein the reaction mixture comprises: a) from 65 to 80 weight percent of the low reactivity coal ash; b) from 0 to 15 weight percent of the calcium bearing material; and c) about 20 weight percent of the alkali activator; wherein the weight percentages are based on the combined total weight of the precursor powder and alkali activator present in the reaction mixture, and wherein the combined weight percentages do not exceed 100%.

Aspect 7: The method of any of aspects 1-6, wherein the low reactivity coal ash comprises less than 40% by weight of CaO and wherein the low reactivity coal ash comprises particles having a median diameter of 50 μm to 400 μm.

Aspect 8: The method of any of aspects 1-7, wherein step a) comprises mixing the reaction mixture for 1 min to 5 min.

Aspect 9: The method of any of aspects 1-8, wherein step b) is performed at 20° C. to 35° C.

Aspect 10: The method of any of aspects 1-9, wherein the reaction mixture is formed into a desired configuration.

Aspect 11: The method of aspect 10, wherein forming into the desired configuration comprises pouring the reaction mixture into a mold, curing the reaction mixture to form a cast, and removing the cast to form the cementitious composite material.

Aspect 12: The method of aspect 10, wherein forming into the desired configuration comprises 3-D printing the reaction mixture to form the cementitious composite material.

Aspect 13: The method of aspect 11, wherein step b) further comprises applying compression during the curing.

Aspect 14: The method of any of aspects 1-13, wherein components i) and ii) are pre-blended prior to addition of water.

Aspect 15: The method of aspect of aspects 1-13, wherein components ii) and iii) are pre-blended to form a solution having a molarity of 10 M to 14 M before mixing with component i).

Aspect 16: A cementitious composite material produced by the method of any of aspects 1-15.

Aspect 17: The cementitious composite material of aspect 16, wherein the cementitious composite material exhibits a compressive strength of 1000 psi to 6000 psi after a period of 28 days at a temperature of 20° C. to 35° C.

Aspect 18: The cementitious composite material of aspect 16 or 17, wherein the cementitious composite material exhibits a compressive strength of 4000 psi to 6000 psi after a period of 28 days at a temperature of 20° C. to 35° C.

Aspect 19: A cementitious composite material comprising: a low reactivity coal ash, wherein the low reactivity coal ash comprises less than 70% by weight of a combined sum of CaO, SiO₂, and Al₂O₃; and an alkali activator.

Aspect 20: The cementitious composite material of aspect 19, wherein the cementitious composite material exhibits a compressive strength of 1000 psi to 6000 psi after a period of 28 days at a temperature of 20° C. to 35° C.

### EXAMPLES

A low reactivity coal ash, such as that exemplified in Tables 1 and 2, was used to prepare a number of sample cementitious composites as described herein. A representative reaction mixture design and activation parameters for evaluated samples is set forth in Table 3. In instances where the 12 Molar NaOH alkali activator solution was first prepared and used, NaOH was first mixed with water to yield the 12 M NaOH solution. The NaOH solution was then mixed with the precursor powders to initiate alkali activation and form a reaction mixture.

TABLE 3

| Mix proportions kg/m³ | | | | Activation Parameters | | |
|---|---|---|---|---|---|---|
| | | Sodium | NaOH | Na₂O/ | Liquid/ | Silica |
| Fly ash | water | Silicate | (12M) | Fly ash | solid | Modulus |
| 500.00 | 112.3 | 162 | 122.3 | 9% | 0.50 | 1.00 |

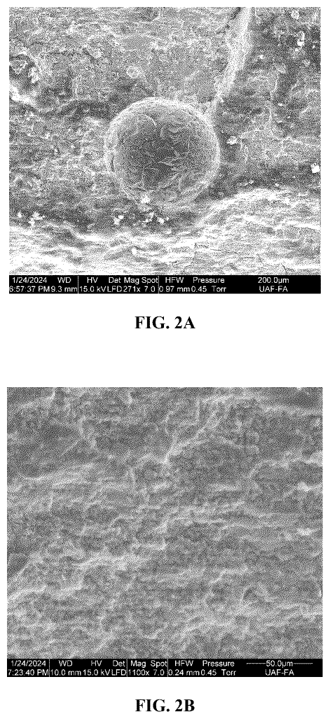

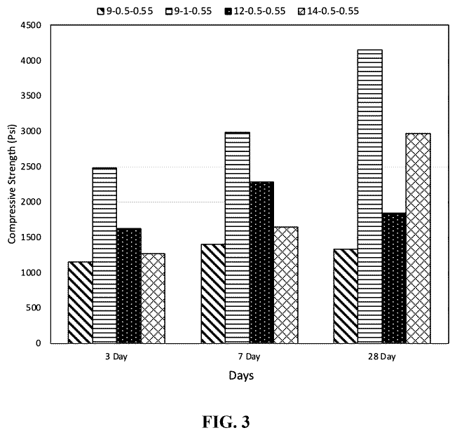

The reaction mixtures were mixed for up to 5 minutes at a relatively high shear rate. The mixtures were reacted and allowed to cure at ambient temperatures for a period of at least 28 days during which time the compression strength was evaluated periodically at day 3, day 7 and day 28. FIGS. 2A and 2B illustrate the microstructural characteristics of sample composites. FIG. 2A is an SEM image of a representative fly ash after activation within the composite matrix. FIG. 2 B is an SEM image illustrating the dense microstructure of a resulting composite. Compressive strength data is shown in FIG. 3. Results indicate that this approach can yield engineering properties and durability comparable to those of Portland cement counterparts. The 28-day compressive strength data obtained for certain composite samples reflected in FIG. 3 ranges between 4000-5000 psi at ambient room temperature, with no additional supplementary materials or curing procedures.

What is claimed is:

1. A method of making a cementitious composite material, comprising:
a) forming a reaction mixture comprising:
i) a cementitious reactive precursor powder comprising a low reactivity coal ash, wherein the low reactivity coal ash comprises less than 70% by weight of a combined sum of CaO, SiO₂, and Al₂O₃;
ii) an alkali activator; and
iii) water; and
b) reacting the mixture of a) to provide the cementitious composite material.

2. The method of claim 1, wherein the low reactivity coal ash is fly ash or bottom ash.

3. The method of claim 1, wherein the alkali activator is NaOH, KOH, or CaCO₃.

4. The method of claim 1, wherein the cementitious reactive precursor powder further comprises a calcium bearing material.

5. The method of claim 4, wherein the calcium bearing material is CaO or CaOH.

6. The method of claim 1, wherein the reaction mixture comprises:
a) from 65 to 80 weight percent of the low reactivity coal ash;
b) from 0 to 15 weight percent of a calcium bearing material; and
c) about 20 weight percent of the alkali activator;
wherein the weight percentages are based on the combined total weight of the precursor powder and alkali activator present in the reaction mixture, and wherein the combined weight percentages do not exceed 100%.

7. The method of claim 1, wherein the low reactivity coal ash comprises less than 40% by weight of CaO and wherein the low reactivity coal ash comprises particles having a median diameter of 50 μm to 400 μm.

8. The method of claim 1, wherein step a) comprises mixing the reaction mixture for 1 min to 5 min.

9. The method of claim 1, wherein step b) is performed at 20° C. to 35° C.

10. The method of claim 1, wherein the reaction mixture is formed into a desired configuration.

11. The method of claim 10, wherein forming into the desired configuration comprises pouring the reaction mixture into a mold, curing the reaction mixture to form the cementitious composite material, and removing it from the mold.

12. The method of claim 10, wherein forming into the desired configuration comprises 3-D printing the reaction mixture to form the cementitious composite material.

13. The method of claim 11, wherein step b) further comprises applying compression during the curing.

14. The method of claim 1, wherein components i) and ii) are pre-blended prior to addition of water.

15. The method of claim 1, wherein components ii) and iii) are pre-blended to form a solution having a molarity of 10 M to 14 M before mixing with component i).

16. A cementitious composite material produced by the method of claim 1.

17. The cementitious composite material of claim 16, wherein the cementitious composite material exhibits a compressive strength of 1000 psi to 6000 psi after a period of 28 days at a temperature of 20° C. to 35° C.

18. The cementitious composite material of claim 17, wherein the cementitious composite material exhibits a compressive strength of 4000 psi to 6000 psi after a period of 28 days at a temperature of 20° C. to 35° C.

19. A cementitious composite material comprising:
a low reactivity coal ash, wherein the low reactivity coal ash comprises less than 70% by weight of a combined sum of CaO, SiO₂, and Al₂O₃; and
an alkali activator.

20. The cementitious composite material of claim 19, wherein the cementitious composite material exhibits a compressive strength of 1000 psi to 6000 psi after a period of 28 days at a temperature of 20° C. to 35° C.
